(19) United States
(12) Patent Application Publication
(10) Pub. No.: US 2021/0341804 A1
(43) Pub. Date: Nov. 4, 2021

(54) DISPLAY DEVICE

(71) Applicant: SHARP KABUSHIKI KAISHA, Osaka (JP)

(72) Inventors: YASUHIRO KUROE, Osaka (JP); NORIYUKI OHASHI, Osaka (JP); YASUYOSHI KAISE, Osaka (JP)

(21) Appl. No.: 17/238,039

(22) Filed: Apr. 22, 2021

Related U.S. Application Data
(60) Provisional application No. 63/017,441, filed on Apr. 29, 2020.

(51) Int. Cl. G02F 1/1362; G02F 1/1339; G02F 1/1333; G06F 3/044; G06F 3/041

(52) U.S. Cl. CPC G02F 1/136209; G02F 1/13394; G02F 1/13398; G02F 1/134363; G02F 1/136286; G06F 3/0446; G06F 3/0412; G02F 1/13338

(57) ABSTRACT

A display device includes an array substrate; a counter substrate facing the array substrate; a color filter disposed on the array substrate or the counter substrate, the color filter being composed of a plurality of colored films; a plurality of pixel electrodes disposed on the array substrate and overlapping the plurality of colored films; a common electrode disposed on the array substrate and closer to the counter substrate than the plurality of pixel electrodes are, the common electrode overlapping the plurality of pixel electrodes with an inter-electrode insulating film interposed between the common electrode and the plurality of pixel electrodes; and a conductive light-blocking portion disposed on the array substrate and overlapping at least a color boundary between the plurality of colored films, the conductive light-blocking portion being closer to the counter substrate than the common electrode is, the conductive light-blocking portion being connected to the common electrode.

### CROSS-REFERENCE TO RELATED APPLICATION

The present application claims priority from Provisional Application No. 63/017,441, the content to which is hereby incorporated by reference into this application.

### BACKGROUND

### 1. Field

The Specification discloses a technique relating to a display device.

### 2. Description of the Related Art

Japanese Patent Application Laid-Open No. 2004-163979 below describes an example of conventional display devices. In Japanese Patent Application Laid-Open No. 2004-163979, an active-matrix liquid crystal display, which is a display device, has a black matrix inserted between a data line and an overcoat layer and along the data line. The dimension of the black matrix is defined in such a manner that the black matrix blocks light that passes, within a predetermined range of a viewing angle, through a region of light leakage occurring within a liquid crystal layer in response to a potential difference between two adjacent pixel electrodes.

In Japanese Patent Application Laid-Open No. 2004-163979, the black matrix inserted along the data line is made of insulating material that blocks light, and thus can reduce the effect of the light leakage region on the data line. Here, when an additional wire capable of signal transmission is necessary, a process step of forming such a wire is required in addition to a process step of forming the black matrix. This unfortunately involves many process steps for manufacturing a TFT substrate.

### SUMMARY

To solve this problem, it is an object of the technique described in the Specification to reduce process steps.

(1) A display device relating to the technique described in the Specification includes the following: an array substrate; a counter substrate facing the array substrate with an interval; a color filter disposed on the array substrate or the counter substrate, the color filter being composed of a plurality of colored films having colors different from each other; a plurality of pixel electrodes disposed on the array substrate and overlapping the plurality of colored films; a common electrode disposed on the array substrate and closer to the counter substrate than the plurality of pixel electrodes are, the common electrode overlapping the plurality of pixel electrodes with an inter-electrode insulating film interposed between the common electrode and the plurality of pixel electrodes; and a conductive light-blocking portion disposed on the array substrate and overlapping at least the color boundary between the plurality of colored films, the conductive light-blocking portion being closer to the counter substrate than the common electrode is, the conductive light-blocking portion being connected to the common electrode.

(2) In addition to (1), the display device may be configured such that the conductive light-blocking portion is made of resin mixed with a conductive material.

(3) In addition to (2), the display device may include a spacer disposed on the counter substrate and protruding toward the array substrate, the spacer being provided for keeping the interval between the array substrate and the counter substrate at equal to or greater than a predetermined distance. The spacer may overlap the conductive light-blocking portion and may be capable of coming into abutment with the conductive light-blocking portion.

(4) In addition to (2) or (3), the display device may be configured such that the conductive light-blocking portion has a thickness equal to or greater than a half of the interval between the array substrate and the counter substrate.

(5) In addition to any of (1) to (4), the display device may be configured such that the color filter is disposed on the array substrate.

(6) In addition to (5), the display device may be configured such that the color filter is more remote from the common electrode than the plurality of pixel electrodes are.

(7) In addition to (6), the display device may include an interlayer insulating film disposed on the array substrate and interposed between the color filter and the plurality of pixel electrodes.

(8) In addition to any of (5) to (7), the display device may include a counter-substrate light-blocking portion disposed on the counter substrate and placed in a location overlapping the conductive light-blocking portion.

(9) In addition to any of (1) to (4), the display device may be configured such that the color filter is disposed on the counter substrate.

(10) In addition to (9), the display device may include a counter-substrate light-blocking portion disposed on the counter substrate and overlapping the color boundary between the plurality of colored films.

(11) In addition to any of (1) to (10), the display device may be configured such that the conductive light-blocking portion has a lattice shape surrounding the plurality of pixel electrodes individually.

(12) In addition to any of (1) to (10), the display device may include a plurality of position detection electrodes composed of the common electrode divided by a partitioning opening, the plurality of position detection electrodes being designed to form, together with a position input element designed to perform position input, a capacitance to detect a position of input performed by the position input element. The conductive light-blocking portion may be disposed on the common electrode with an insulating film interposed between the conductive light-blocking portion and the common electrode. The conductive light-blocking portion may be closer to the counter substrate than the common electrode is. The conductive light-blocking portion may at least partly constitute a plurality of position detection wires connected to the plurality of respective position detection electrodes.

(13) In addition to (12), the display device may include an image wire disposed on the array substrate and being more remote from the counter substrate than the conductive light-blocking portion is, the image wire overlapping the conductive light-blocking portion with at least the inter-electrode insulating film interposed between the image wire and the conductive light-blocking portion, the image wire being connected to the plurality of pixel electrodes. The display device may be configured such that the conductive light-blocking portion partly overlaps the plurality of position detection electrodes, but does not overlap the partitioning opening, and such that the conductive light-blocking portion partly constitutes a dummy wire connected to an overlapping position detection electrode included in the plurality of position detection electrodes.

The technique in this Specification can reduce process steps.

### BRIEF DESCRIPTION OF DRAWINGS

FIG. 1 is a plan view of a liquid crystal panel included in a liquid crystal display according to a first preferred embodiment;

FIG. 2 is a plan view of a pixel arrangement in a display area of an array substrate included in the liquid crystal panel;

FIG. 3 is a sectional view near the end of the liquid crystal panel cut in its shorter-side direction;

FIG. 4 is a sectional view near the end of the liquid crystal panel cut in its longer-side direction;

FIG. 5 is a sectional view near the end of a liquid crystal panel according to a second preferred embodiment, cut in its shorter-side direction;

FIG. 6 is a sectional view near the end of the liquid crystal panel cut in its longer-side direction;

FIG. 7 is a sectional view near the end of a liquid crystal panel according to a third preferred embodiment, cut in its shorter-side direction;

FIG. 8 is a sectional view near the end of the liquid crystal panel cut in its longer-side direction;

FIG. 9 is a sectional view near the end of a liquid crystal panel according to a fourth preferred embodiment, cut in its shorter-side direction;

FIG. 10 is a sectional view near the end of the liquid crystal panel cut in its longer-side direction;

FIG. 11 is a schematic plan view of touch electrodes, touch wires and other components of a liquid crystal panel according to a fifth preferred embodiment;

FIG. 12 is a sectional view near the end of the liquid crystal panel cut in its shorter-side direction;

FIG. 13 is a sectional view near the end of the liquid crystal panel (touch wires) cut in its longer-side direction;

FIG. 14 is an enlarged plan view near the touch electrodes, the touch wires and dummy wires of the liquid crystal panel; and

FIG. 15 is a sectional view near the middle of the liquid crystal panel (dummy wires) cut in its longer-side direction.

### DETAILED DESCRIPTION

### First Preferred Embodiment

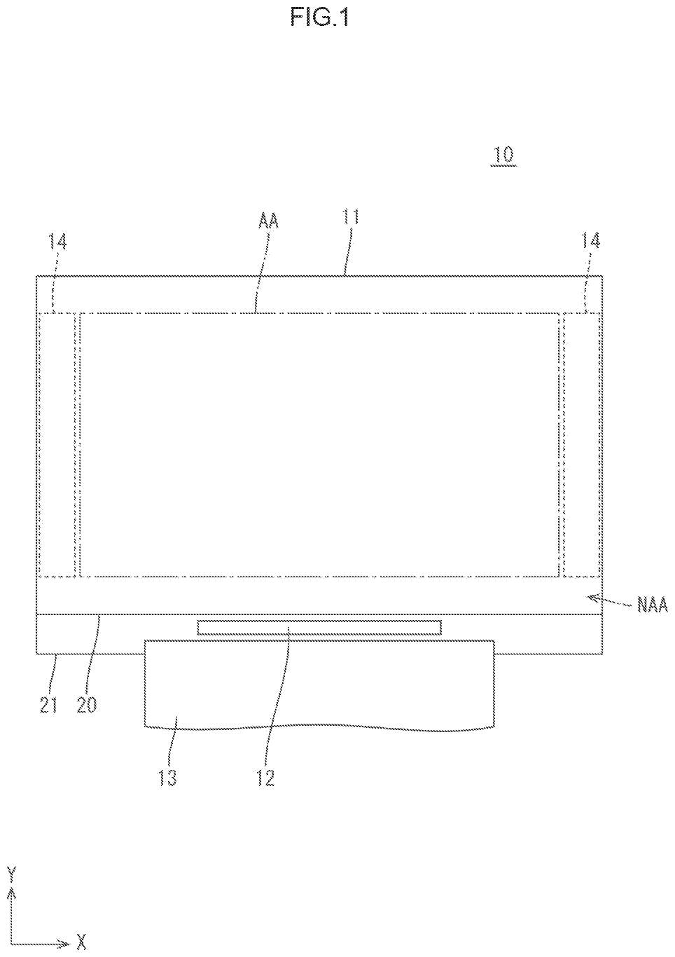

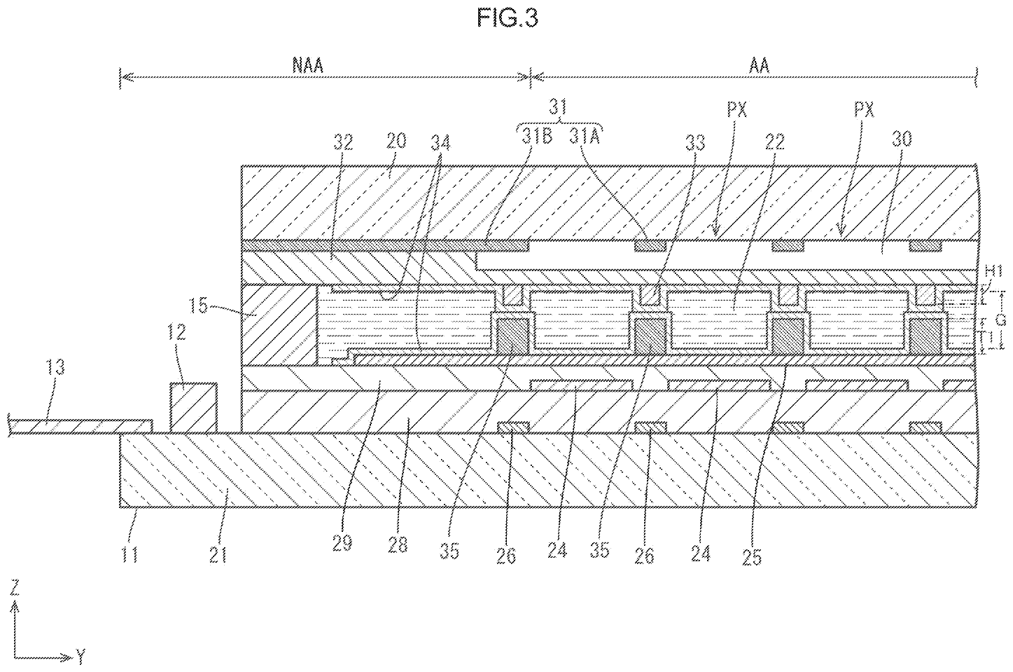

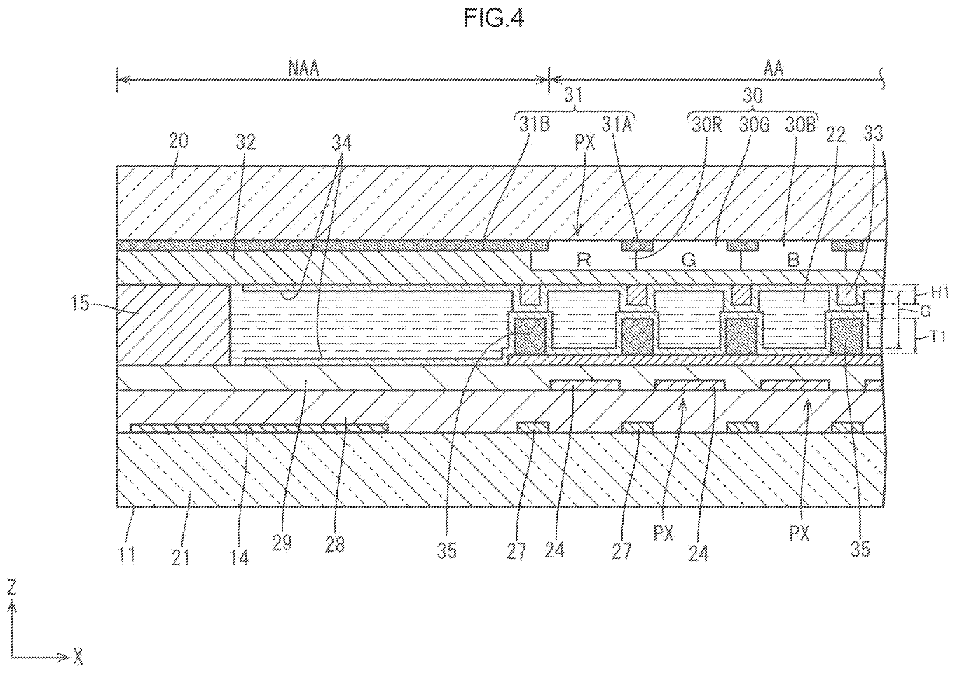

A first preferred embodiment will be described with reference to FIGS. 1 to 4. The following describes, by way of example, a liquid crystal panel (display device or display panel) 11 included in a liquid crystal display 10. It is noted that there are an X-axis, a Y-axis, and a Z-axis shown in part of each drawing, and the direction of each axis is oriented as is in each drawing. It is also noted that an up-and-down direction is defined with reference to FIGS. 3 and 4, and that the panel's front side is oriented to the upper part of each of these drawings, and the panel's back side is oriented to the lower part of the drawing.

The liquid crystal display 10 includes at least the following, as illustrated in FIG. 1: the liquid crystal panel 11 having a horizontally oriented rectangular shape and capable of displaying an image; and a backlight (illumination device), which is an external light source, that emits light for display to the liquid crystal panel 11. The shorter-side direction, longer-side direction, and thickness direction of the liquid crystal panel 11 correspond to the Y-axis direction, X-axis direction, and Z-axis direction, respectively. The backlight is disposed on the back side (back surface) of the liquid crystal panel 11. The backlight has, but not limited to, a light source (e.g., an LED) that emits white light, and an optical member that converts, through application of an optical action, light from the light source into planar light.

The liquid crystal panel 11 has, in the middle of its display surface, a display area AA (defined by a dot-dashed line in FIG. 1) where an image is displayed, as illustrated in FIG. 1. The liquid crystal panel 11 also has a non-display area NAA where an image is not displayed. The non-display area NAA is disposed on the display surface and is located around a quadrangular frame (perimeter) surrounding the display area AA. The liquid crystal panel 11 is composed of a pair of substrates 20 and 21 joined together. The pair of substrates 20 and 21 consists of a counter substrate 20, which is on the front side, and an array substrate 21, which is on the back side. Each of the counter substrate 20 and array substrate 21 is composed of a glass substrate with various films laminated on its inner surface. Each of the substrates 20 and 21 has a polarizer plate attached on its outer surface.

As illustrated in FIG. 1, the array substrate 21 is longer in the shorter-side direction than the counter substrate 20 in the shorter-side direction, and is joined to the counter substrate 20 in such a manner that one of the ends of the array substrate 21 in the shorter-side direction (Y-axis direction) coincides with the corresponding end of the counter substrate 20. The array substrate 21 thus does not overlap the counter substrate 20 at its other end in the shorter-side direction; on this other end, a driver (signal supplying portion) 12 and a flexible substrate (signal transmitting portion) 13 are mounted. The driver 12 is composed of an LSI chip incorporating a drive circuit, is mounted on the array substrate 21 through chip-on-glass (COG), and processes various signals transmitted by the flexible substrate 13. The flexible substrate 13 has a pattern of many wires (not shown) on a base composed of an insulating and flexible synthetic resin (e.g., polyimide resin). The flexible substrate 13 has one end connected to the array substrate 21, and the other end connected to an external control substrate (source of signal supply). Various signals supplied from the control substrate are transmitted through the flexible substrate 13 to the liquid crystal panel 11. The array substrate 21 includes, in the non-display area NAA, a pair of gate circuit sections 14 sandwiching the display area AA from both sides in the X-axis direction. The gate circuit sections 14 are provided for supplying a scan signal to gate wires 26, which will be described later on, and are disposed on the array substrate 21 in a monolithic manner.

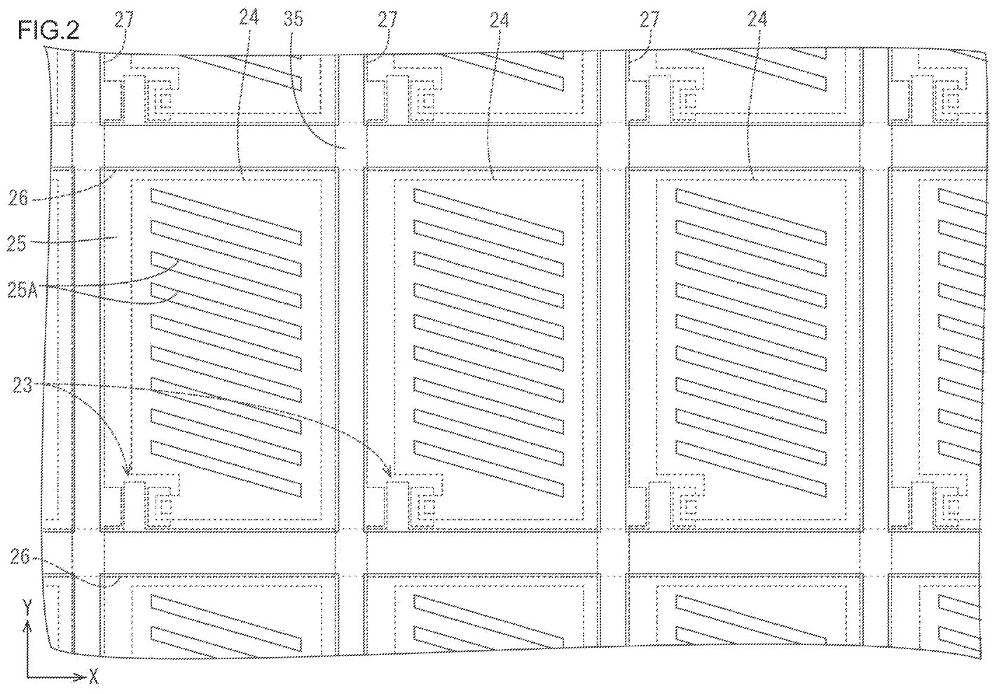

The array substrate 21 of the liquid crystal panel 11 has, on its inner surface facing the counter substrate 20, a plurality of TFTs or thin-film transistors (switching elements) 23 and a plurality of pixel electrodes 24 both disposed in the display area AA, as illustrated in FIG. 2. The TFTs 23 are arranged in matrix (rows and columns) in each of the X- and Y-axis directions at intervals; so are the pixel electrodes 24. Around the TFTs 23 and pixel electrodes 24 are a plurality of gate wires (scan wires) 26 and a plurality of source wires (image wires or data wires) 27. The gate wires 26 are orthogonal to (cross) the source wires 27. The gate wires 26 and the source wires 27 are composed of two metal films disposed in different layers with an insulating film therebetween. The gate wires 26 extend in the X-axis direction, and the source wires 27 extend in the Y-axis direction. The respective metal films constituting the gate wires 26 and source wires 27 conduct electricity and block light. The gate wires 26 are connected to the gate electrodes of the TFTs 23. The source wires 27 are connected to the source electrodes of the TFTs 23. The pixel electrodes 24 are connected to the drain electrodes of the TFTs 23. The TFTs 23 are driven in response to a scan signal transmitted to the gate wires 26, thus enabling charging of the pixel electrodes 24 to a potential based on an image signal transmitted to the source wires 27. The pixel electrodes 24 are composed of a transparent electrode film, such as an indium tin oxide (ITO), and are vertically oriented rectangles in a plan view. Above the matrix-arranged pixel electrodes 24 is a common electrode 25 overlapping. Like the pixel electrodes 24, the common electrode 25 is composed of a transparent electrode film, such as an ITO. The common electrode 25 extends, in a planar manner, almost all across the array substrate 21 so as to overlap all the pixel electrodes 24. The common electrode 25 has a plurality of slits or openings 25A disposed in each location overlapping the pixel electrode 24. The common electrode 25 is supplied with common potential signals having a predetermined common potential (reference potential). The respective transparent electrode films constituting the pixel electrodes 24 and common electrode 25 conduct electricity and block light.

As illustrated in FIGS. 3 and 4, the liquid crystal panel 11 has a liquid crystal layer (medium layer) 22 containing liquid crystal molecules, which are substances filled in the inner space between the pair of substrates 20 and 21 and having an optical property that varies along with application of an electric field. The liquid crystal layer 22 is sealed by a sealing portion 15 surrounding the inner space between the pair of substrates 20 and 21. The sealing portion 15 is disposed in the non-display area NAA, and is in the form of a quadrangular frame (end-free loop) surrounding the entire inner space between the substrates 20 and 21. A flattening film (insulating film) 28 is disposed between the metal films, constituting the gate wires 26 and source wires 27, and the transparent electrode film, constituting the pixel electrodes 24 and disposed on the upper layer (close to the counter substrate 20) of the metal films. The flattening film 28 avoids a short circuit between each of the wires 26 or 27 and the pixel electrodes 24. An inter-electrode insulating film 29 is disposed between the transparent electrode film (first transparent electrode film) constituting the pixel electrodes 24 and the transparent electrode film (second transparent electrode film) constituting the common electrode 25 and disposed on the upper layer (close to the counter substrate 20) of the pixel electrodes 24. The inter-electrode insulating film 29 avoids a short circuit between the pixel electrodes 24 and common electrode 25. The flattening film 28 is made of organic resin, and is thicker than the inter-electrode insulating film 29 to flatten a surface constituting a base for the pixel electrodes 24. The inter-electrode insulating film 29 is made of inorganic resin, and is thinner than the flattening film 28 to keep the strength of an electric field that occurs between the pixel electrodes 24 and common electrode 25, at a high level. Upon driving of the TFTs 23, the pixel electrodes 24 are charged to a potential based on an image signal transmitted to the source wires 27, thereby producing a potential difference between the pixel electrodes 24 and common electrode 25. Accordingly, a fringe electric field (oblique electric field) containing a component in the direction of the normal to a surface of the array substrate 21 as well as a component along the surface of the array substrate 21 occurs between the opening edges of the slits 25A of the common electrode 25 and the pixel electrodes 24. As such, using this fringe electric field can control the alignment of the liquid crystal molecules within the liquid crystal layers 22; based on this molecule alignment, predetermined display is performed. The liquid crystal panel 11 according to this preferred embodiment operates in a fringe-field switching (FFS) mode. Although schematically illustrated in FIG. 4, the gate circuit sections 14 are formed on the array substrate 21 in a monolithic manner by using, but not limited to, the metal films constituting the gate wires 26 and source wires 27.

As illustrated in FIGS. 3 and 4, the counter substrate 20 of the liquid crystal panel 11 has, on its inner surface facing the array substrate 21, a color filter 30 disposed in the display area AA and consisting of colored films 30B, 30G, and 30R of three colors: blue (B), green (G), and red (R). The color filter 30 includes a blue colored film 30B of blue, a green colored film 30G of green, and a red colored film 30R of red. Each of the colored films 30B, 30G and 30R is repeatedly arranged in the X-axis direction, where the gate wires 26 extend, and extends in the Y-axis direction, where the source wires 27 extend, thus forming a stripe-shaped arrangement as a whole. The colored films 30B, 30G, and 30R overlap, in a plan view, the respective pixel electrodes 24, which are on the array substrate 21. In the liquid crystal panel 11, the colored films 30B, 30G, 30R of R, G and B, arranged in the X-axis direction, and three pixel electrodes 24 facing the respective colored films 30B, 30G, 30R constitute respective pixel portions PX of three colors. In the liquid crystal panel 11, the pixel portions PX of three colors: R, G, and B adjacent to one another in the Y-axis direction constitute a display pixel capable of color display with predetermined gradation.

The counter substrate 20 has a counter-substrate light-blocking portion 31 on its inner surface, as illustrated in FIGS. 3 and 4. The counter-substrate light-blocking portion 31 is composed of an insulating light-blocking film that is insulating and blocks light, and exerts its light-blocking performance when it absorbs most of light. The counter-substrate light-blocking portion 31 extends astride the display area AA and the non-display area NAA. The counter-substrate light-blocking portion 31 consists of a display-area light-blocking portion (inter-pixel light-blocking portion) 31A disposed in the display area AA, and a non-display-area light-blocking portion (peripheral light-blocking portion) 31B disposed in the non-display area NAA. The display-area light-blocking portion 31A has, in a plan view, a lattice shape sectioning the pixel portions PX, which are arranged in matrix in a plan view. The display-area light-blocking portion 31A can thus block light that travels between the adjacent pixel portions PX. This achieves display independency between the pixel portions PX. The display-area light-blocking portion 31A overlaps the gate wires 26 and the source wires 27 in a plan view. The non-display-area light-blocking portion 31B is disposed almost all across the non-display area NAA in a flat manner, and has a quadrangular frame shape surrounding the display area AA in a plan view. The non-display-area light-blocking portion 31B avoids light leakage in the non-display area NAA to maintain display quality.

On the upper layer (close to the array substrate 21) of the color filter 30 and counter-substrate light-blocking portion 31 is a counter-substrate flattening film 32 disposed almost all across the counter substrate 20 in a flat manner, as illustrated in FIGS. 3 and 4. The counter-substrate flattening film 32 is made of organic insulating material, and extends astride the display area AA and non-display area NAA on the inner surface of the counter substrate 20. The counter-substrate flattening film 32 flattens a stepped part caused by the color filter 30 and counter-substrate light-blocking portion 31 in the inner surface of the counter substrate 20. Disposed on the upper layer of the counter-substrate flattening film 32 is a plurality of spacers 33 for keeping an interval (thickness of the liquid crystal layer 22) G between the pair of substrates 20 and 21, that is, a cell gap, at equal to or greater than a predetermined distance. Each spacer 33 has a columnar shape protruding in the Z-axis direction from the surface of the counter-substrate flattening film 32 toward the array substrate 21. The spacers 33 overlap the respective gate wires 26 and the respective source wires 27. Each of the substrates 20 and 21 has, on its innermost surface being in contact with the liquid crystal layer 22, an alignment film 34 for aligning the liquid crystal molecules within the liquid crystal layer 22.

The array substrate 21 of the liquid crystal panel 11 according to this preferred embodiment has conductive light-blocking portion 35 overlapping at least the color boundaries between the colored films 30B, 30G, and 30R, as illustrated in FIG. 4. The conductive light-blocking portion 35 extends in the Z-axis direction (direction of the normal to the surface of the array substrate 21) on the upper layer of the common electrode 25, that is, close to the counter substrate 20. The conductive light-blocking portion 35 is in direct contact with the common electrode 25, and is thus connected to the common electrode 25.

Here, an image is displayed using light emitted from the backlight to the liquid crystal panel 11. Light impinging from the backlight onto the array substrate 21 travels through the matrix-arranged pixel electrodes 24, then through the liquid crystal layer 22, and then through the colored films 30B, 30G, and 30R, disposed on the counter substrate 20 and overlapping the pixel electrodes 24, and the light then exits. This offers display with predetermined gradation relating to the color of each of the colored films 30B, 30G and 30R. During the course of this process, light passing through a certain pixel electrode 24 and traveling obliquely possibly transmits through the colored films 30B, 30G, or 30R overlapping the pixel electrode 24 adjacent to the certain pixel electrode 24, to thus possibly mix with light passing through the adjacent pixel electrode 24 and through the overlapping colored film 30B, 30G, or 30R. On that regard, the conductive light-blocking portion 35, which is disposed on the array substrate 21 so as to overlap the color boundaries between the colored films 30B, 30G, and 30R, can block light passing through a certain pixel electrode 24 and traveling obliquely, before the light reaches the colored films 30B, 30G, and 30R overlapping the adjacent pixel electrodes 24. Light beams passing through the counter substrate 20 are accordingly less likely to mix with one another, less causing faulty display such as display gradation different from that originally intended. In particular, the array substrate 21 is configured such that the common electrode 25 overlaps the pixel electrodes 24 with the inter-electrode insulating film 29 interposed therebetween and is closer to the counter substrate 20 than the pixel electrodes 24 are, and such that the conductive light-blocking portion 35 is closer to the counter substrate 20 than the common electrode 25 is. The conductive light-blocking portion 35 can thus efficiently block light traveling obliquely, thus less causing mixture of light pasting through the counter substrate 20. Faulty display is consequently further less likely to occur. In addition, the conductive light-blocking portion 35, which is connected to the common electrode 25, can supply signals, including a common potential signal, to the common electrode 25. This successfully reduces the resistance distribution of the common electrode 25. As described above, the conductive light-blocking portion 35 can block light traveling obliquely, and the conductive light-blocking portion 35, which is connected to the common electrode 25, can transmit a common potential signal to the common electrode 25. Such a functional combination of light blockage and signal transmission can reduce the number of process steps when compared to a conventional configuration where structures for these respective functions need to be formed in separate process steps.

The conductive light-blocking portion 35 has, in a plan view, a lattice shape surrounding the matrix-arranged pixel electrodes 24 individually, as illustrated in FIGS. 2 to 4. As illustrated in FIG. 3, the lattice-shaped conductive light-blocking portion 35 sections, in the X-axis direction, the pixel portions PX of the same color, and blocks light traveling between the pixel portions PX of the same color adjacent to each other in the Y-axis direction. As illustrated in FIG. 4, the lattice-shaped conductive light-blocking portion 35 sections, in the Y-axis direction, the pixel portions PX of different colors, and blocks light traveling between the pixel portions PX of different colors adjacent to each other in the X-axis direction. In either case, light beams are less likely to mix with each other between the pixel portions PX adjacent to each other in the X-axis direction and between the pixel portions PX adjacent to each other in the Y-axis direction. Consequently, faulty display such as display gradation different from that originally intended is less likely to occur. Furthermore, the lattice-shaped conductive light-blocking portion 35, which is connected to the common electrode 25, successfully reduces the resistance distribution of the common electrode 25 when compared to a conductive light-blocking portion having a linear shape in the X- or Y-axis direction. The lattice-shaped conductive light-blocking portion 35 overlaps, in the X-axis direction, the gate wires 26 and overlaps, in the Y-axis direction, the source wires 27.

As illustrated in FIGS. 3 and 4, the conductive light-blocking portion 35 is composed of a conductive light-blocking film stacked on the upper layer of the transparent electrode film constituting the common electrode 25. The conductive light-blocking film constituting the conductive light-blocking portion 35 is made of resin mixed with a conductive material, and the film conducts electricity and blocks light. To enhance the performance of light blockage, it is preferable, but not necessarily limited, that the conductive light-blocking film constituting the conductive light-blocking portion 35 undergo black coloring so that its surface is black. Doing so facilitates increasing the thickness of the conductive light-blocking portion 35 when compared to a conductive light-blocking portion made of only metal. The thickness of the conductive light-blocking portion 35 thus easily increases, thereby more efficiently blocking light traveling obliquely. Consequently, light beams passing through the counter substrate 20 are further less likely to mix with one another. To be specific, the conductive light-blocking portion 35 has a thickness T1 equal to or greater than a half of the interval G between the array substrate 21 and counter substrate 20. That is, the thickness T1 of the conductive light-blocking portion 35 satisfies an inequality T1>G/2. As such, the conductive light-blocking portion 35 can more efficiently block light traveling obliquely than a conductive light-blocking portion having a thickness less than the half of the interval G between the array substrate 21 and counter substrate 20.

Accordingly, light beams passing through the counter substrate 20 are further less likely to mix with one another. Moreover, the conductive light-blocking portion 35 overlaps the spacers 33. Each spacer 33 has a protruding extremity capable of coming into indirect abutment with the conductive light-blocking portion 35 via the alignment films 34. The spacers 33 come into abutment with the conductive light-blocking portion 35, thus keeping the interval G between the array substrate 21 and counter substrate 20 at equal to or greater than a predetermined distance. As described above, the conductive light-blocking portion 35 also has a capability of receiving the spacers 33. This offers less process steps than a configuration where a structure that receives the spacers 33 is provided separately from the conductive light-blocking portion 35. Here, the thickness T1 of the conductive light-blocking portion 35 according to this preferred embodiment is greater than a height H1 of each spacer 33.

As descried above, the liquid crystal panel (display device) 11 according to this preferred embodiment includes the following: the array substrate 21; the counter substrate 20 facing the array substrate 21 with the interval G; the color filter 30 disposed on the counter substrate 20, the color filter 30 being composed of the plurality of colored films 30B, 30G, and 30R having colors different from each other; the plurality of pixel electrodes 24 disposed on the array substrate 21 and overlapping the plurality of colored films 30B, 30G, and 30R; the common electrode 25 disposed on the array substrate 21 and closer to the counter substrate 20 than the plurality of pixel electrodes 24 are, the common electrode 25 overlapping the plurality of pixel electrodes 24 with the inter-electrode insulating film 29 interposed therebetween; and the conductive light-blocking portion 35 disposed on the array substrate 21, the conductive light-blocking portion 35 overlapping at least the color boundaries between the plurality of colored films 30B, 30G, and 30R, the conductive light-blocking portion 35 being closer to the counter substrate 20 than the common electrode 25 is, the conductive light-blocking portion 35 being connected to the common electrode 25.

In such a configuration, charging the pixel electrodes 24 on the array substrate 21 produces a potential difference between the charged pixel electrodes 24 and the common electrode 25, which is closer to the counter substrate 20 than the pixel electrodes 24 are and overlaps the pixel electrodes 24 with the inter-electrode insulating film 29 interposed therebetween. Based on the potential difference, the amount of light passing through the array substrate 21 and counter substrate 20 is regulated. The pixel electrodes 24 constitute the color filter 30 and overlap the colored films 30B, 30G, and 30R of colors different from each other. Thus, light passing through the pixel electrodes 24 passes through the colored films 30B, 30G, and 30R, which overlap the respective pixel electrodes 24, thereby providing display with predetermined gradation relating to the color of each of the colored films 30B, 30G and 30R. Here, reference is made to an instance where the color filter 30 is disposed on the counter substrate 20. When light passing through a certain pixel electrode 24 travels obliquely, mixes with light passing through the adjacent pixel electrode 24, and then passes through the counter substrate 20, display gradation can be different from that originally intended.

On that regard, the array substrate 21 has the conductive light-blocking portion 35, which overlaps at least the color boundaries between the colored films 30B, 30G, and 30R. As such, for the color filter 30 disposed on the counter substrate 20, light passing through a certain pixel electrode 24, even when traveling obliquely, is blocked by the conductive light-blocking portion 35, which is disposed at the color boundary between the colored film 30B, 30G, or 30R overlapping the certain pixel electrode 24 and the adjacent colored film 30B, 30G, or 30R. Accordingly, light beams passing through the counter substrate 20 are less likely to mix with one another. In particular, the array substrate 21 is configured such that the common electrode 25 overlaps the pixel electrodes 24 with the inter-electrode insulating film 29 interposed therebetween and is closer to the counter substrate 20 than the pixel electrodes 24 are, and such that the conductive light-blocking portion 35 is closer to the counter substrate 20 than the common electrode 25 is. The conductive light-blocking portion 35 can thus efficiently block light traveling obliquely, thus less causing mixture of light pasting through the counter substrate 20. Consequently, faulty display, such as display gradation different from that originally intended, is further less likely to occur. In addition, the conductive light-blocking portion 35, which is connected to the common electrode 25, can supply signals, including a common potential signal, to the common electrode 25. This successfully reduces the resistance distribution of the common electrode 25. As described above, the conductive light-blocking portion 35 can block light traveling obliquely, and the conductive light-blocking portion 35, which is connected to the common electrode 25, can transmit a signal to the common electrode 25. Such a functional combination of light blockage and signal transmission can reduce the number of process steps when compared to a conventional configuration where structures for these respective functions need to be formed in separate process steps.

The conductive light-blocking portion 35 is made of resin mixed with a conductive material. Doing so facilitates increasing the thickness of the conductive light-blocking portion 35 when compared to a conductive light-blocking portion made of only metal. The thickness T1 of the conductive light-blocking portion 35 thus increases easily, thereby more efficiently blocking light traveling obliquely. Consequently, light beams passing through the counter substrate 20 are further less likely to mix with one another.

The spacers 33 on the counter substrate 20 protrude toward the array substrate 21. The spacers 33 are provided for keeping the interval G between the array substrate 21 and counter substrate 20 at equal to or greater than a predetermined distance. The spacers 33 overlap the conductive light-blocking portion 35 and can come into abutment with the conductive light-blocking portion 35. As such, the spacers 33 disposed on the counter substrate 20 can come into abutment with the conductive light-blocking portion 35 disposed on the array substrate 21, thus keeping the interval G between the array substrate 21 and counter substrate 20 at equal to or greater than a predetermined distance. The conductive light-blocking portion 35 can also have a capability of receiving the spacers 33. This can further reduce the number of process steps.

The thickness T1 of the conductive light-blocking portion 35 is equal to or greater than the half of the interval G between the array substrate 21 and counter substrate 20. As such, the conductive light-blocking portion 35 can more efficiently block light traveling obliquely than a conductive light-blocking portion having a thickness less than the half of the interval G between the array substrate 21 and counter substrate 20. Accordingly, light beams passing through the counter substrate 20 are further less likely to mix with one another.

The counter-substrate light-blocking portion 31 is disposed on the counter substrate 20 and overlaps the color boundaries between the colored films 30B, 30G, and 30R. Accordingly, light passing through the pixel electrodes 24 and traveling obliquely in the array substrate 21 is blocked by both the conductive light-blocking portion 35 on the array substrate 21, and the counter-substrate light-blocking portion 31 on the counter substrate 20. Light beams passing through the counter substrate 20 are accordingly less likely to mix with one another, further less causing faulty display such as display gradation different from that originally intended.

The conductive light-blocking portion 35 has a lattice shape surrounding the pixel electrodes 24 individually. As such, the lattice-shaped conductive light-blocking portion 35 individually surrounding the pixel electrodes 24 is connected to the common electrode 25. The conductive light-blocking portion 35 thus successfully reduces the resistance distribution of the common electrode 25 when compared to a conductive light-blocking portion having a linear shape in one direction.

### Second Preferred Embodiment

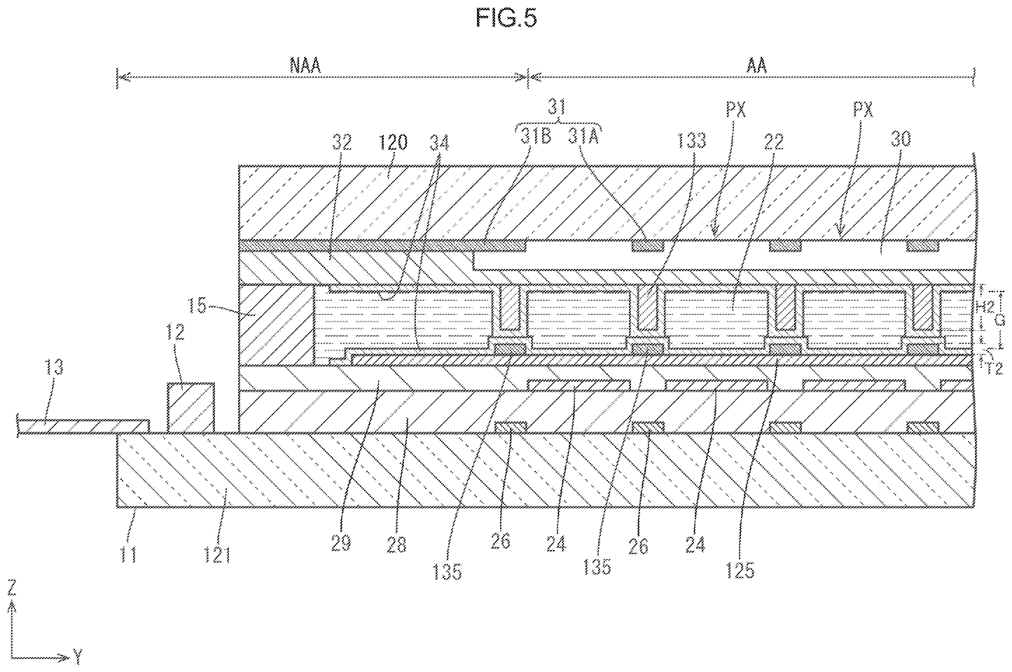

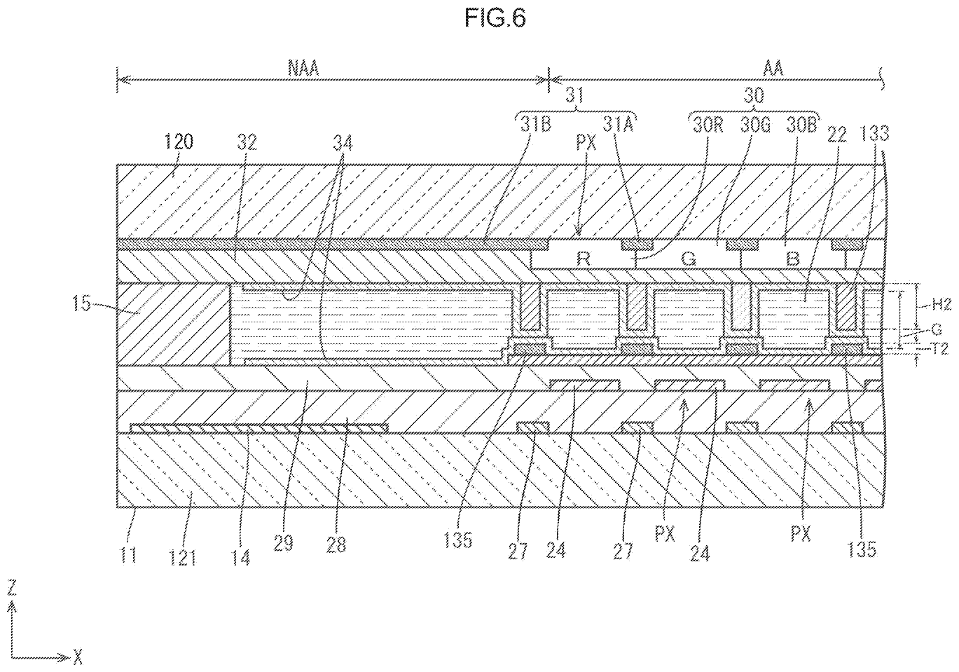

A second preferred embodiment will be described with reference to FIG. 5 or 6. The second preferred embodiment describes the configuration of a conductive light-blocking portion 135, which is a modification. Structures, actions and effects similar to those in the first preferred embodiment and redundant will not be elaborated upon here.

The conductive light-blocking portion 135 according to this preferred embodiment is composed of a metal film (conductive light-blocking film) made of only metal without resins, as illustrated in FIGS. 5 and 6. The metal film constituting the conductive light-blocking portion 135 conducts electricity and blocks light. To enhance the performance of light blockage, it is preferable, but not necessarily limited, that the metal film constituting the conductive light-blocking portion 135 undergo black coloring so that its surface is black. Doing so enables the metal film constituting the conductive light-blocking portion 135 to have higher conductivity than the corresponding film described in the first preferred embodiment, and doing so is hence more preferable for reducing the resistance distribution of a common electrode 125. The conductive light-blocking portion 135 has a thickness T2 that is smaller than a half of an interval G between an array substrate 121 and a counter substrate 120, and that is smaller than a height H2 of each spacer 133. The height H2 of the spacer 133 is greater than the half of the interval G between the array substrate 121 and counter substrate 120.

### Third Preferred Embodiment

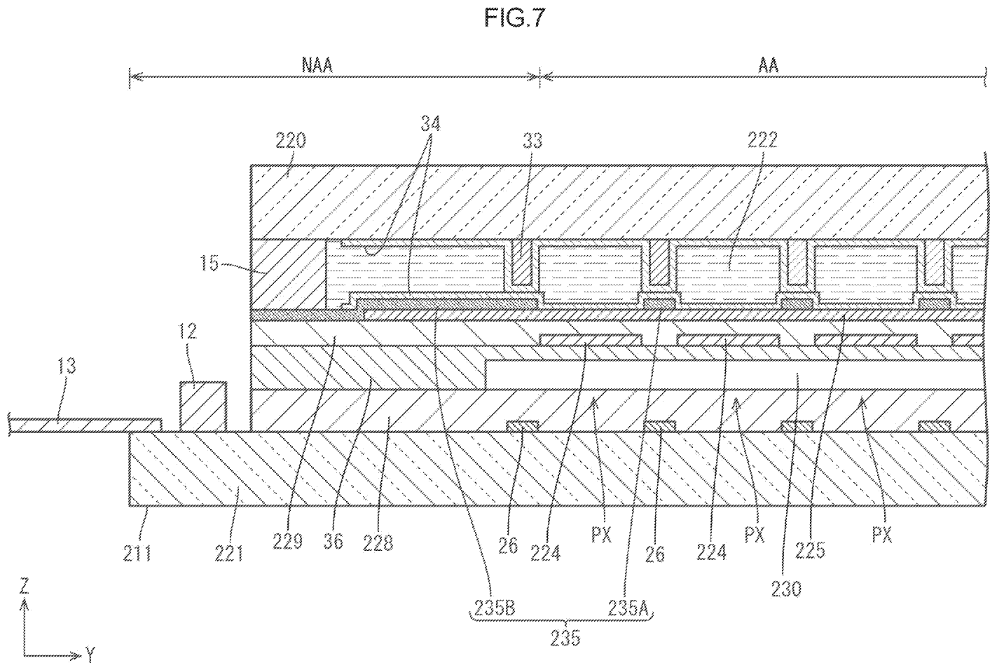

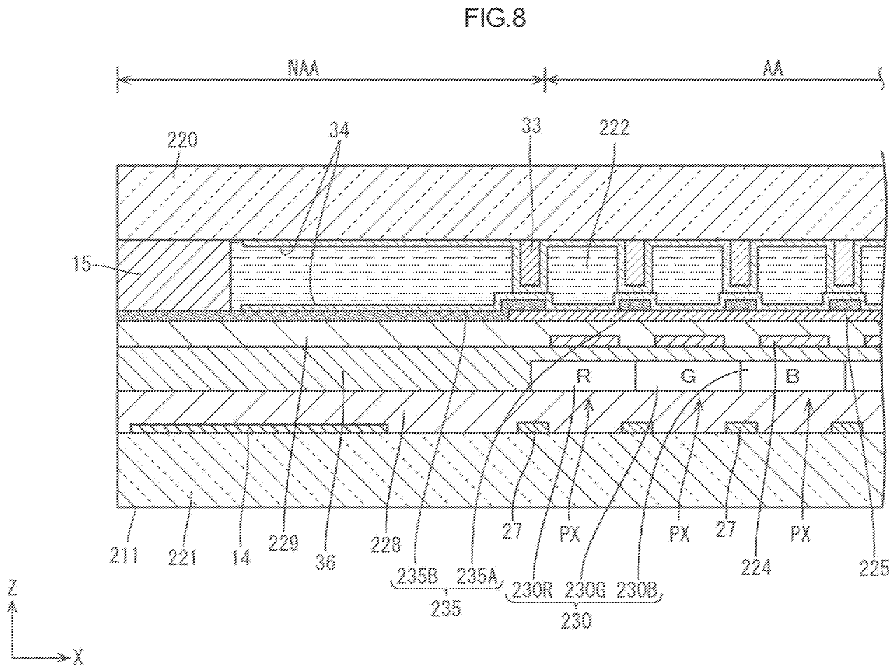

A third preferred embodiment will be described with reference to FIG. 7 or 8. The third preferred embodiment describes the configuration of a color filter 230, which is a modification of that in the second preferred embodiment. Structures, actions and effects similar to those in the second preferred embodiment and redundant will not be elaborated upon here.

The color filter 230 according to this preferred embodiment is disposed on an array substrate 221, as illustrated in FIGS. 7 and 8. The color filter 230 is disposed below pixel electrodes 224 on the array substrate 221; that is, the color filter 230 is more remote from a common electrode 225 (counter substrate 220) than the pixel electrodes 224 are. To be specific, the color filter 230 is stacked on the upper layer of a flattening film 228, which corresponds to the flattening film described in the first preferred embodiment. The color filter 230 consists of colored films 230B, 230G, and 230R. The pixel electrodes 224 are composed of a transparent electrode film. Disposed between the colored films 230B, 230G and 230R and the transparent electrode film is an upper flattening film (interlayer insulating film) 36. Like the flattening film 228, the upper flattening film 36 is made of organic resin, and the upper flattening film 36 is thicker than an inter-electrode insulating film 229 to flatten a surface constituting a base for the pixel electrodes 224.

For image display, a backlight emits light, which then impinges on the array substrate 221 and passes through the colored films 230B, 230G and 230R, through the matrix-arranged pixel electrodes 224, through a liquid crystal layer 222, and then through the counter substrate 220 to exit. This provides display with predetermined gradation relating to the color of each of the colored films 230B, 230G and 230R. During the course of this process, light passing through a certain colored film 230B, 230G, or 230R and traveling obliquely to the counter substrate 220 possibly transmits through a part of the counter substrate 220 overlapping the colored film 230B, 230G, or 230R adjacent to the certain colored film 230B, 230G, or 230R, through which the light passes, thereby possibly causing light mixture. On that regard, the array substrate 221 includes a conductive light-blocking portion 235 overlapping the color boundaries between the colored films 230B, 230G, and 230R. The conductive light-blocking portion 235 can block light passing through a certain colored film 230B, 230G, or 230R and traveling obliquely, before the light reaches the part of the counter substrate 220 overlapping the adjacent colored films 230B, 230G, or 230R. Light beams passing through the counter substrate 220 are accordingly less likely to mix with one another, preventing color mixture and thus less causing faulty display such as color unevenness.

The color filter 230 is more remote from the common electrode 225 than the pixel electrodes 224 are. The color filter 230 is thus away from the conductive light-blocking portion 235 when compared to a color filter closer to the common electrode 225 than the pixel electrodes 224 are. Consequently, the conductive light-blocking portion 235 can further efficiently block light passing through the colored films 230B, 230G, and 230R and traveling obliquely, thereby further less causing color mixture in light passing through the counter substrate 220. In addition, such a configuration can keep the interval between the pixel electrodes 224 and common electrode 225 at a small distance when compared to a color filter closer to the common electrode 225 than the pixel electrodes 224 are. This can maintain a high-intensity electric field between the pixel electrodes 224 and common electrode 225, thus offering favorable display quality. Furthermore, the upper flattening film 36 on the array substrate 221 is interposed between the color filter 230 and pixel electrodes 224. Thus, the interval between the conductive light-blocking portion 235 and color filter 230 is greater, by the thickness of the upper flattening film 36, than that in an instance where pixel electrodes are directly stacked on a color filter. Consequently, the conductive light-blocking portion 235 can further efficiently block light passing through the colored films 230B, 230G, and 230R and traveling obliquely, thereby further less causing color mixture in light passing through the counter substrate 220.

The conductive light-blocking portion 235 according to this preferred embodiment has the following: a display-area conductive light-blocking portion 235A disposed in the display area AA and having a lattice shape; and a non-display-area conductive light-blocking portion 235B disposed in the non-display area NAA. The display-area conductive light-blocking portion 235A is configured in a manner similar to that in the conductive light-blocking portion 135, described in the second preferred embodiment. The non-display-area conductive light-blocking portion 235B is disposed almost all across the non-display area NAA in a flat manner, and the non-display-area conductive light-blocking portion 235B has a quadrangular frame shape surrounding the display area AA in a plan view. The non-display-area conductive light-blocking portion 235B avoids light leakage in the non-display area NAA to maintain display quality. That is, the non-display-area conductive light-blocking portion 235B has the same function as the non-display-area light-blocking portion 31B, described in the first preferred embodiment.

As descried above, this preferred embodiment provides a liquid crystal panel 211 that includes the following: the array substrate 221; the counter substrate 220 facing the array substrate 221 with the interval G; the color filter 230 disposed on the array substrate 221, the color filter 230 being composed of the plurality of colored films 230B, 230G, and 230R having colors different from each other; the plurality of pixel electrodes 224 disposed on the array substrate 221 and overlapping the plurality of colored films 230B, 230G, and 230R; the common electrode 225 disposed on the array substrate 221 and closer to the counter substrate 220 than the plurality of pixel electrodes 224 are, the common electrode 225 overlapping the plurality of pixel electrodes 224 with the inter-electrode insulating film 229 interposed therebetween; and the conductive light-blocking portion 235 disposed on the array substrate 221, the conductive light-blocking portion 235 overlapping at least the color boundaries between the plurality of colored films 230B, 230G, and 230R, the conductive light-blocking portion 235 being closer to the counter substrate 220 than the common electrode 225 is, the conductive light-blocking portion 235 being connected to the common electrode 225.

In such configuration, charging the pixel electrodes 224 on the array substrate 221 produces a potential difference between the charged pixel electrodes 224 and the common electrode 225, which is closer to the counter substrate 220 than the pixel electrodes 224 are and overlaps the pixel electrodes 224 with the inter-electrode insulating film 229 interposed therebetween. Based on the potential difference, the amount of light passing through the array substrate 221 and counter substrate 220 is regulated. The pixel electrodes 224 constitute the color filter 230, and overlap the colored films 230B, 230G, and 230R of colors different from each other. Thus, light passing through the pixel electrodes 224 passes through the colored films 230B, 230G, and 230R, which overlap the respective pixel electrodes 224, thereby providing display with predetermined gradation relating to the color of each of the colored films 230B, 230G and 230R. Here, reference is made to an instance where the color filter 230 is disposed on the array substrate 221. When light passing through a certain colored film 230B, 230G, or 230R travels obliquely, mixes with light passing through a pixel electrode 224 overlapping the adjacent colored film 230B, 230G, or 230R, and then passes through the counter substrate 220, color mixture can occur and be visible as color unevenness.

On that regard, the conductive light-blocking portion 235 overlapping at least the color boundaries between the colored films 230B, 230G, and 230R is disposed on the array substrate 221. As such, for the color filter 230 disposed on the array substrate 221, light passing through a certain colored film 230B, 230G, or 230R, even when traveling obliquely, is blocked by the conductive light-blocking portion 235, which is disposed at the color boundary between the certain colored film 230B, 230G, or 230R and the adjacent colored film 230B, 230G, or 230R. Accordingly, light beams are less likely to mix with one another, less causing color mixture in light passing through the counter substrate 220. In particular, the array substrate 221 is configured such that the common electrode 225 overlaps the pixel electrodes 224 with the inter-electrode insulating film 229 interposed therebetween and is closer to the counter substrate 220 than the pixel electrodes 24 are, and such that the conductive light-blocking portion 235 is closer to the counter substrate 220 than the common electrode 255 is. The conductive light-blocking portion 235 can thus efficiently block light traveling obliquely, thus less causing mixture of light pasting through the counter substrate 220. Faulty display, such as color unevenness, is consequently less likely to occur. In addition, the conductive light-blocking portion 235, which is connected to the common electrode 225, can supply signals, including a common potential signal, to the common electrode 225. This successfully reduces the resistance distribution of the common electrode 225. As described above, the conductive light-blocking portion 235 can block light traveling obliquely, and the conductive light-blocking portion 235, which is connected to the common electrode 225, can transmit a signal to the common electrode 225. Such a functional combination of light blockage and signal transmission can reduce the number of process steps when compared to a conventional configuration where structures for these respective functions need to be formed in separate process steps.

The color filter 230 is more remote from the common electrode 225 than the pixel electrodes 224 are. Doing so offers a large interval between the conductive light-blocking portion 235 and color filter 230 when compared to a color filter closer to the common electrode 225 than the pixel electrodes 224 are. Consequently, the conductive light-blocking portion 235 can block light passing through the colored films 230B, 230G, and 230R and traveling obliquely. Color mixture is accordingly less likely to occur in light passing through the counter substrate 220. In addition, such a configuration can keep the interval between the pixel electrodes 224 and common electrode 225 at a small distance when compared to a color filter closer to the common electrode 225 than the pixel electrodes 224 are. This can maintain a high-intensity electric field between the pixel electrodes 224 and common electrode 225, thus offering favorable display quality.

The upper flattening film (interlayer insulating film) 36 is disposed on the array substrate 221 and interposed between the color filter 230 and pixel electrodes 224. Thus, the interval between the conductive light-blocking portion 235 and color filter 230 is greater, by the thickness of the upper flattening film 36, than that in an instance where pixel electrodes are directly stacked on a color filter. Consequently, the conductive light-blocking portion 235 can block light passing through the colored films 230B, 230G, and 230R and traveling obliquely. Color mixture is accordingly less likely to occur in light passing through the counter substrate 220.

### Fourth Preferred Embodiment

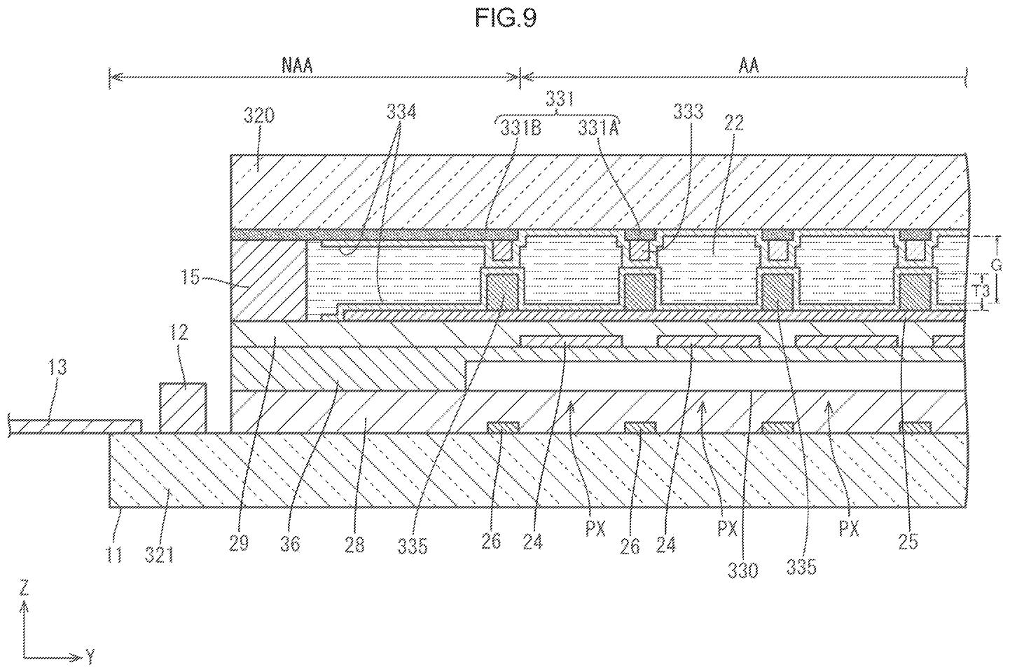

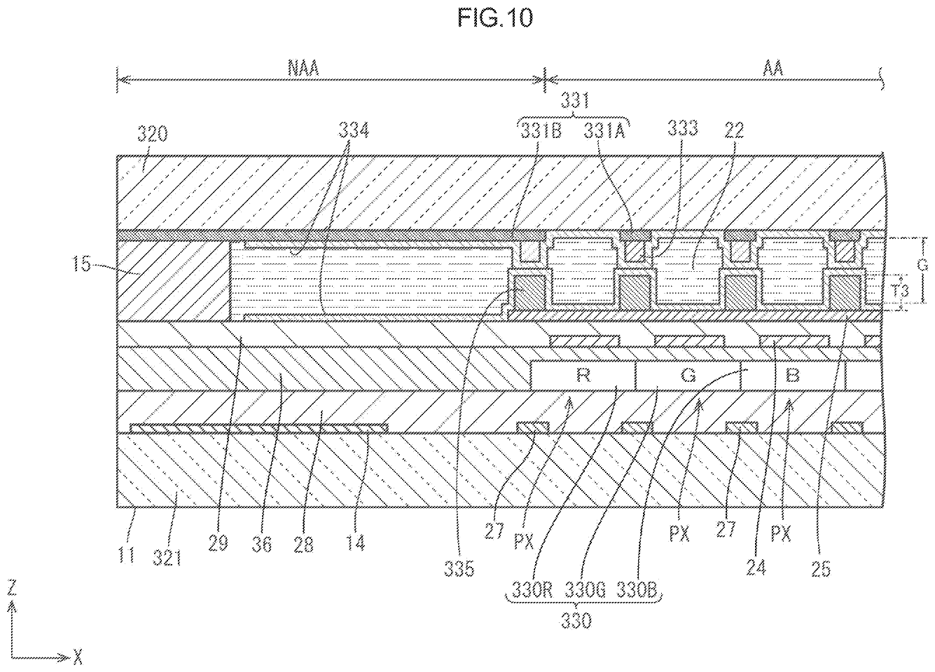

A fourth preferred embodiment will be described with reference to FIG. 9 or 10. The fourth preferred embodiment describes the configuration of a conductive light-blocking portion 335, which is a modification of that in the third preferred embodiment. Structures, actions and effects similar to those in the third preferred embodiment and redundant will not be elaborated upon here.

The conductive light-blocking portion 335 according to this preferred embodiment is composed of a conductive light-blocking film made of resin mixed with a conductive material, as illustrated in FIGS. 9 and 10. That is, the conductive light-blocking portion 335 is composed of a conductive light-blocking film similar to that constituting the conductive light-blocking portion 35, described in the first preferred embodiment. The conductive light-blocking portion 335 has a thickness T3 equal to or greater than a half of an interval G between an array substrate 321 and a counter substrate 320. That is, the thickness T3 of the conductive light-blocking portion 335 satisfies an inequality T3>G/2. Moreover, the conductive light-blocking portion 335 overlaps spacers 333. Each spacer 333 has a protruding extremity capable of coming into indirect abutment with the conductive light-blocking portion 335 via alignment films 334. As described above, the conductive light-blocking portion 335 according to this preferred embodiment achieves an action and effect similar to those described in the first preferred embodiment.

The conductive light-blocking portion 335 has such a configuration as described above. Accordingly, the counter substrate 320, having no color filter 330, includes a counter-substrate light-blocking portion 331 at least partly overlapping the conductive light-blocking portion 335. The counter-substrate light-blocking portion 331 consists of a display-area light-blocking portion 331A disposed in the display area AA, and a non-display-area light-blocking portion 331B disposed in the non-display area NAA. The counter-substrate light-blocking portion 331 is configured in a manner similar to that in the counter-substrate light-blocking portion 31, described in the first preferred embodiment. In such a configuration, light passing through colored films 330B, 330G, 330R on the array substrate 321 and traveling obliquely is blocked by both the conductive light-blocking portion 335 on the array substrate 321, and the counter-substrate light-blocking portion 331 on the counter substrate 320. Accordingly, color mixture is further less likely to occur in light passing through the counter substrate 320, and faulty display such as color unevenness is thus further less likely to occur.

In this preferred embodiment, the counter-substrate light-blocking portion 331 is disposed on the counter substrate 320 and placed in a location overlapping the conductive light-blocking portion 335, as earlier described. In such a configuration, light passing through the colored films 330B, 330G, 330R on the array substrate 321 and traveling obliquely is blocked by both the conductive light-blocking portion 335 on the array substrate 321, and the counter-substrate light-blocking portion 331 on the counter substrate 320. Accordingly, color mixture is further less likely to occur in light passing through the counter substrate 320, and faulty display such as color unevenness is thus further less likely to occur.

### Fifth Preferred Embodiment

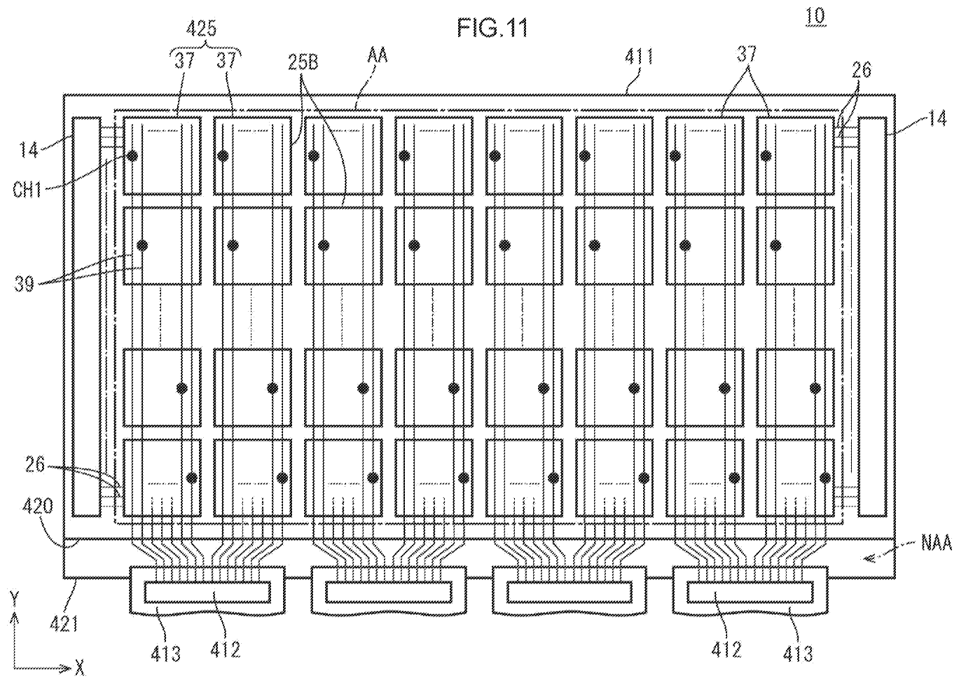

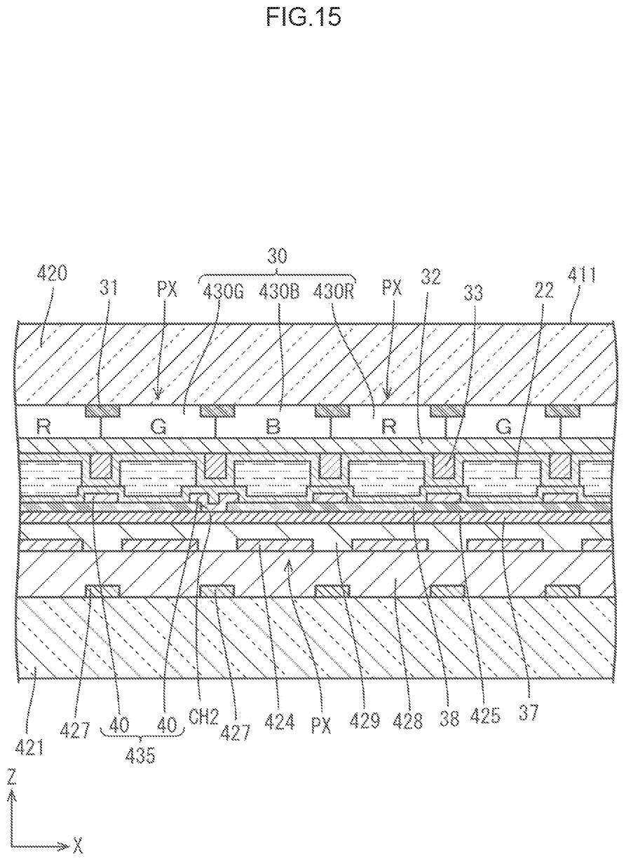

A fifth preferred embodiment will be described with reference to FIGS. 11 to 15. The fifth preferred embodiment describes the configuration of a common electrode 425 and other things, which are modifications of the first preferred embodiment. Structures, actions and effects similar to those in the first preferred embodiment and redundant will not be elaborated upon here.

This preferred embodiment provides a liquid crystal panel 411. The liquid crystal panel 411 can display an image, and has a touch panel function, where the liquid crystal panel 411 can detect the position of a user input (input position) on the basis of a displayed image. The liquid crystal panel 411 integrates a touch panel pattern (such a panel is called an in-cell touch panel) for performing its touch panel function. To form this touch panel pattern, this preferred embodiment provides a common electrode 425. The common electrode 425 has, as illustrated in FIG. 11, a partitioning opening (partitioning slit) 25B, by which the common electrode 425 is divided into a plurality of touch electrodes (position detection electrodes) 37 constituting the touch panel pattern. Specifically, the partitioning opening 25B consists of parts horizontally traversing the entire common electrode 425 in the X-axis direction, and parts longitudinally traversing the entire common electrode 425 in the Y-axis direction. The partitioning opening 25B has a lattice shape as a whole in a plan view. The common electrode 425 is divided into a grid in a plan view by the lattice-shaped partitioning opening 25B, thus forming the multiple touch electrodes 37 electrically independent of one another. The touch panel pattern consisting of the touch electrodes 37 uses a “projected capacitive method”, where a user touch is detected through a self-capacitive method.

The multiple touch electrodes 37, constituting the touch panel pattern, are arranged in matrix in each of the X- and Y-axis directions in the display area AA of the liquid crystal panel 411, as illustrated in FIG. 11. Thus, the display area AA of the liquid crystal panel 411 almost coincides with a touch area (position-input area) where an input position can be detected, and the non-display area NAA of the liquid crystal panel 411 almost coincides with a non-touch area (non-position-input area) where an input position cannot be detected. When a user brings his/her finger (position-input element), a conductor, close to the surface of the liquid crystal panel 411 in order to perform position input on the basis of an image on the display area AA of the liquid crystal panel 411 visible to the user, a capacitance is formed between the finger and touch electrodes 37. Accordingly, a capacitance detected at the touch electrode 37 near the finger varies along with finger approach and becomes different from that at the touch electrode 37 far away from the finger. Based on this difference, an input position can be detected. Each touch electrode 37 is substantially quadrangular in a plan view, and has sides each being about several millimeter (e.g., about 2 to 6 mm) long. The touch electrodes 37 are much larger than the pixel portions PX in a plan view, and a plurality of touch electrodes 37 (e.g., several tens of electrodes) are arranged in each of the X- and Y-axis directions in a region extending over the pixel portions PX. Herein, FIG. 11 schematically illustrates an arrangement of the touch electrodes 37; a specific number of touch electrodes 37, their specific placement, their specific shape in a plan view, and other things can be modified as necessary.

The touch electrodes 37 are selectively connected to a plurality of touch wires (position detection wires) 39 disposed in the liquid crystal panel 411, as illustrated in FIG. 11. The touch wires 39 extend almost all across the touch area in the Y-axis direction and traverse all the touch electrodes 37 arranged in the Y-axis direction. That is, the touch wires 39 overlap each of the touch electrodes 37 arranged in the Y-axis direction, and the touch wires 39 overlap each part of the partitioning opening 25B partitioning the touch electrodes 37 adjacent to each other in the Y-axis direction. The touch wires 39 are selectively connected to particular touch electrodes 37 among the touch electrodes 37 arranged in the Y-axis direction. Here, FIG. 11 illustrates black dots, each of which denotes the connection (a touch-wire contact hole CH1, which will be described later on) between the touch electrode 37 and touch wire 39. The touch wires 39 are connected to a detection circuit. The detection circuit may be included in a driver 412 or may be placed outside the liquid crystal panel 411 via a flexible substrate 413. The touch wires 39 connected to the touch electrodes 37 supply a common potential signal, relating to the display function, and a touch signal (position detection signal), relating to the touch function, to the touch electrodes 37 through time division. The common potential signal is transmitted to all the touch wires 39 at the same timing; accordingly, all the touch electrodes 37 have a common potential to function as the common electrode 425. It is noted that the non-display area NAA of the liquid crystal panel 411 according to this preferred embodiment is connected to four flexible substrates 413 on each of which the driver 412 is mounted through chip-on-film (COF).

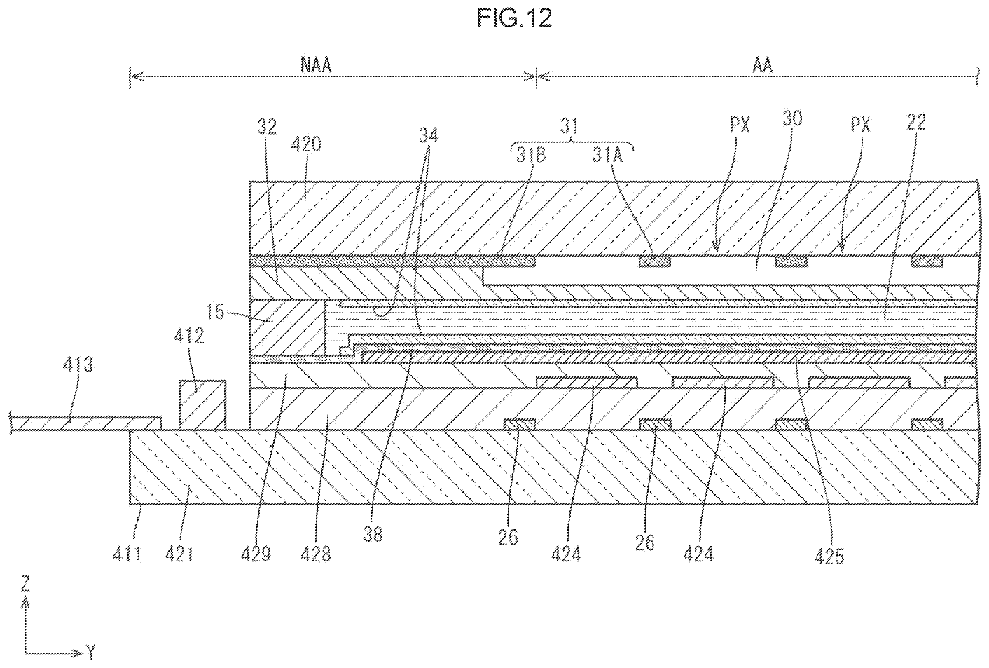

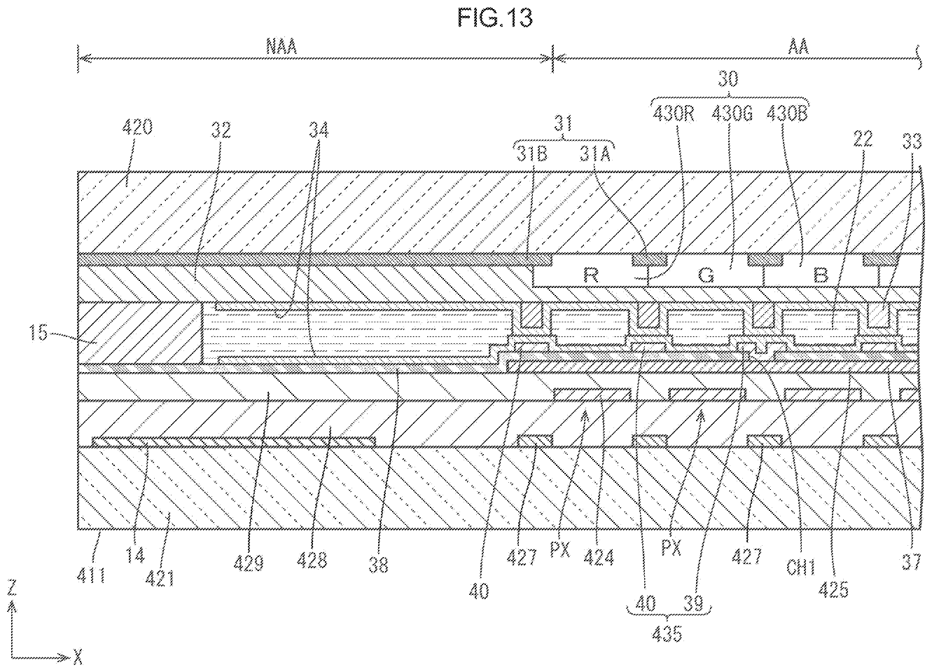

This preferred embodiment provides a conductive light-blocking portion 435. The conductive light-blocking portion 435 is substantially linear in the Y-axis direction, and overlaps the color boundaries between colored films 430B, 430G, and 430R, as illustrated in FIGS. 12 and 13. The conductive light-blocking portion 435 partitions the pixel portions PX adjacent to each other in the X-axis direction and having colors different from each other. The conductive light-blocking portion 435 can block light traveling between these pixel portions PX of different colors adjacent to each other in the X-axis direction. Accordingly, color mixture is less likely to occur in light passing through a counter substrate 420, and faulty display such as color unevenness is thus less likely to occur. The conductive light-blocking portion 435 overlaps source wires 427 with a flattening film 428 and inter-electrode insulating film 429 interposed therebetween. The conductive light-blocking portion 435 partly constitutes the touch wires 39. Specifically, the conductive light-blocking portion 435 constituting the touch wires 39 is disposed on the upper surface of the common electrode 425 (adjacent to the counter substrate 420) with an insulating film 38 interposed therebetween. The insulating film 38 keeps the touch wires 39, traversing all the touch electrodes 37 arranged in the Y-axis direction, insulated from the non-connected touch electrodes 37 to avoid a short circuit. The insulating film 38 has the touch wire contact holes CH1, openings, each disposed in where the touch wire 39 overlaps the connected touch electrode 37. Each touch wire 39 is connected to the corresponding touch electrode 37 via the touch-wire contact hole CH1. As such, the conductive light-blocking portion 435 constitutes the multiple touch wires 39 and can supply signals to the touch electrodes 37. This configuration can further reduce the number of process steps.

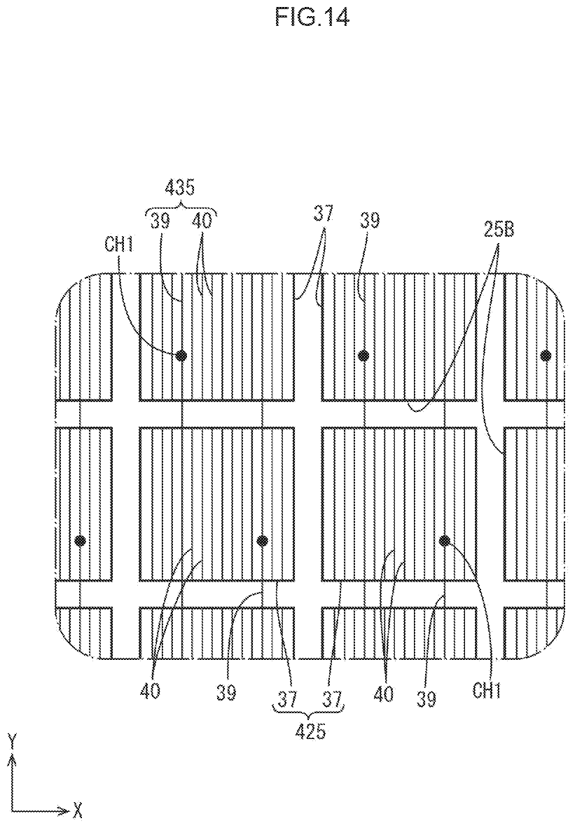

The conductive light-blocking portion 435 constitutes dummy wires 40 partly (i.e., the conductive light-blocking portion 435 excluding the parts constituting the touch wires 39), as illustrated in FIGS. 13 to 15. The dummy wires 40 are similar to the touch wires 39 in that each wire is substantially linear in the Y-axis direction. However, the dummy wires 40 are different from the touch wires 39 in that their formation range in the Y-axis direction is limited to the formation range of the touch electrodes 37 in the Y-axis direction. That is, the dummy wires 40 overlap the touch electrodes 37, but do not overlap the partitioning opening 25B. The dummy wires 40 consist of all, excluding a single touch wire 39, of each conductive light-blocking portion 435 overlapping a single touch electrode 37. The multiple dummy wires 40 are each connected to the overlapping touch electrode 37. The insulating film 38 interposed between each dummy wire 40 and each touch electrode 37 overlapping each other has a dummy-wire contact hole CH2, which is an opening. Via the dummy-wire contact hole CH2, the overlapping dummy wire 40 and touch electrode 37 are connected together. For easy illustration, only the touch-wire contact holes CH1 are denoted by black dots in FIG. 14. As described, the touch electrodes 37 are connected to the touch wires 39 and dummy wires 40, thus reducing the resistance distribution of the touch electrodes 37. The dummy wire 40, which overlaps the connected touch electrode 37 but does not overlap the partitioning opening 25B, is less likely to have a parasitic capacitance occurring between the dummy wire 40 and non-connected touch electrode 37 than a dummy wire overlapping the partitioning opening 25B and straddling the multiple touch electrodes 37.

As described above, this preferred embodiment provides the plurality of touch electrodes (position detection electrodes) 37 composed of the common electrode 425 divided by the partitioning opening 25B. Each touch electrode 37 forms, together with a position input element that performs position input, a capacitance to detect the position of input performed by the position input element. Moreover, the conductive light-blocking portion 435 is disposed on the common electrode 425 with the insulating film 38 interposed therebetween, and the conductive light-blocking portion 435 is closer to the counter substrate 420 than the common electrode 425 is. The conductive light-blocking portion 435 at least partly constitutes the plurality of touch wires (position detection wires) 39 connected to the respective touch electrodes 37. In such a configuration, the touch electrodes 37, composed of the common electrode 425 divided by the partitioning opening 25B, are connected to the respective touch wires 39. Together with the position input element that performs position input, each touch electrode 37 can form a capacitance, to detect the position of input performed by the position input element by using a signal supplied from the corresponding touch wire 39. The conductive light-blocking portion 435 constitutes the multiple touch wires 39 and can supply a signal to the touch electrodes 37. This can further reduce the number of process steps.

The source wires (image wires) 427 are disposed on the array substrate 421. The source wires 427 are more remote from the counter substrate 420 than the conductive light-blocking portion 435 is. The source wires 427 overlap the conductive light-blocking portion 435 with at least the inter-electrode insulating film 429 interposed therebetween. The source wires 427 are connected to pixel electrodes 424. The conductive light-blocking portion 435 partly overlaps the touch electrodes 37 but does not overlap the partitioning opening 25B. The conductive light-blocking portion 435 partly constitutes the dummy wires 40 connected to the overlapping touch electrodes 37. In such a configuration, the pixel electrodes 424 are charged to a potential based on a signal transmitted from the connected source wires 427. The source wires 427 overlap the conductive light-blocking portion 435 with at least the inter-electrode insulating film 429 interposed therebetween, and the source wires 427 are more remote from the counter substrate 420 than the conductive light-blocking portion 435 is. The source wires 427 can thus block, together with the conductive light-blocking portion 435, obliquely traveling light when the source wires 427 are made of material that blocks light. The touch electrodes 37 are connected to the touch wires 39 and dummy wires 40, thus reducing the resistance distribution of the touch electrodes 37. Each dummy wire 40, which overlaps the connected touch electrode 37 but does not overlap the partitioning opening 25B, is less likely to have a parasitic capacitance occurring between the dummy wire 40 and non-connected touch electrode 37 than a dummy wire overlapping the partitioning opening 25B and straddling the multiple touch electrodes 37.

### Other Preferred Embodiments

The technique disclosed in the Specification is not limited to the preferred embodiments described above with reference to the drawings. Other example preferred embodiments below are also included in the scope of the technique.

(1) The spacers 33, 133, or 333 are not in abutment with the conductive light-blocking portion 35, 135, 235, 335, or 435 when an external force is not exerted on the liquid crystal panel 11, 211, or 411. The spacers 33, 133, or 333 each may have such a height as to come into abutment with the conductive light-blocking portion 35, 135, 235, 335, or 435 when an external force is exerted on the liquid crystal panel 11, 211, or 411 to, for instance, deform the counter substrate 20, 120, 220, 320, or 420.

(2) The conductive light-blocking portion 35, 135, 235, 335, or 435 may be provided so as not to overlap the spacers 33, 133, or 333 in part or in whole.

(3) Various modifications can be devised, including a specific range where the conductive light-blocking portion 35, 135, 235, 335, or 435 extends in a plan view.

(4) Referring to the first and fourth preferred embodiments, the thickness of the conductive light-blocking portion 35, 135, 235, 335, or 435 may be smaller than a half of the interval G between the array substrate 21, 121, 221, 321, or 421 and the counter substrate 20, 120, 220, 320, or 420.

(5) In a modification of the third preferred embodiment, the counter-substrate light-blocking portion 31 or 331, described in the fourth preferred embodiment for instance, can be added.

(6) In a modification of the first, second, fourth and fifth preferred embodiments, the counter-substrate light-blocking portion 31 or 331 may be omitted.

(7) In a modification of the third and fourth preferred embodiments, the insulating film 38 may be omitted, and the color filter 30, 230, or 330 may be directly stacked on the upper layer of the pixel electrodes 24, 224, or 424.

(8) In a modification of the third and fourth preferred embodiments, the color filter 30, 230, or 330 may be closer to the common electrode 25, 125, 225, or 425 than the pixel electrodes 24, 224, or 424 are.

(9) In a modification of the fifth preferred embodiment, a plurality of touch wires 39 may be connected to a single touch electrode 37. In this case, the number of dummy wires 40 is to be changed in accordance with the number of touch wires 39 connected to the touch electrode 37.

(10) In the color filters 30, 230, and 330, the colored films 30B, 30G, 30R, 130B, 130G, 130R, 230B, 230G, 230R, 330B, 330G and 330R may consist of four or more colors. In addition, the color filter 30, 230, or 330 may include an uncolored film other than the colored films 30B, 30G and 30R, the colored films 130B, 130G and 130R, the colored films 230B, 230G and 230R, or the colored films 330B, 330G and 330R. An uncolored film does not take on a particular color, and transmits light emitted from a backlight with little modification.

(11) A specific number of drivers 12 or 412 and a specific number of flexible substrates 13 or 413 can be modified as appropriate.

(12) In the first to fourth preferred embodiments, the driver 12 or 412 may be mounted on the flexible substrate 13 or 413 through COF.

(13) In the fifth preferred embodiment, the driver 12 or 412 may be mounted directly on the array substrate 21, 121, 221, 321, or 421 through COG.

(14) A specific shape of each slit 25A in a plan view, disposed on the common electrode 25, 125, 225, or 425 can be modified as appropriate. A specific number of slits 25A, a specific pitch of arrangement of the slits 25A, and other things can be also modified as appropriate.

(15) The gate circuit sections 14 can be omitted. In this case, the array substrate 21, 121, 221, 321, or 421 may have a gate driver having a function similar to that of the gate circuit sections 14. Moreover, the gate circuit section 14 can be placed on only one side of the array substrate 21, 121, 221, 321, or 421.

(16) The liquid crystal panels 11, 211, and 411 may operate in, but not limited to, an IPS display mode.

(17) The touch panel pattern may use a mutual-capacitive method.

(18) The liquid crystal panels 11, 211, and 411 may be a reflective panel or a semitransparent panel.

(19) The liquid crystal display 10 may have a shape in a plan view, including a vertically oriented rectangle, a square, a circle, a semi-circle, an ellipse, an oval, and a trapezoid.

(20) A display panel (e.g., an organic EL display panel) other than the liquid crystal panels 11, 211, and 411 can be used.

While there have been described what are at present considered to be certain embodiments of the application, it will be understood that various modifications may be made thereto, and it is intended that the appended claim cover all such modifications as fall within the true spirit and scope of the application.

What is claimed is:

1. A display device comprising:
an array substrate;
a counter substrate facing the array substrate with an interval;
a color filter disposed on the array substrate or the counter substrate, the color filter being composed of a plurality of colored films having colors different from each other;
a plurality of pixel electrodes disposed on the array substrate and overlapping the plurality of colored films;
a common electrode disposed on the array substrate and closer to the counter substrate than the plurality of pixel electrodes are, the common electrode overlapping the plurality of pixel electrodes with an inter-electrode insulating film interposed between the common electrode and the plurality of pixel electrodes; and
a conductive light-blocking portion disposed on the array substrate and overlapping at least a color boundary between the plurality of colored films, the conductive light-blocking portion being closer to the counter substrate than the common electrode is, the conductive light-blocking portion being connected to the common electrode.

2. The display device according to claim 1, wherein
the conductive light-blocking portion is made of a resin mixed with a conductive material.

3. The display device according to claim 2, comprising
a spacer disposed on the counter substrate and protruding toward the array substrate, the spacer being provided for keeping the interval between the array substrate and the counter substrate at equal to or greater than a predetermined distance,
wherein the spacer overlaps the conductive light-blocking portion and is capable of coming into abutment with the conductive light-blocking portion.

4. The display device according to claim 2, wherein
the conductive light-blocking portion has a thickness equal to or greater than a half of the interval between the array substrate and the counter substrate.

5. The display device according to claim 1, wherein
the color filter is disposed on the array substrate.

6. The display device according to claim 5, wherein
the color filter is more remote from the common electrode than the plurality of pixel electrodes are.

7. The display device according to claim 6, comprising
an interlayer insulating film disposed on the array substrate and interposed between the color filter and the plurality of pixel electrodes.

8. The display device according to claim 5, comprising
a counter-substrate light-blocking portion disposed on the counter substrate and placed in a location overlapping the conductive light-blocking portion.

9. The display device according to claim 1, wherein
the color filter is disposed on the counter substrate.

10. The display device according to claim 9, comprising
a counter-substrate light-blocking portion disposed on the counter substrate and overlapping the color boundary between the plurality of colored films.

11. The display device according to claim 1, wherein
the conductive light-blocking portion has a lattice shape surrounding the plurality of pixel electrodes individually.

12. The display device according to claim 1, comprising
a plurality of position detection electrodes composed of the common electrode divided by a partitioning opening, the plurality of position detection electrodes being configured to form, together with a position input element configured to perform position input, a capacitance to detect a position of input performed by the position input element,
wherein the conductive light-blocking portion is disposed on the common electrode with an insulating film interposed between the conductive light-blocking portion and the common electrode, the conductive light-blocking portion is closer to the counter substrate than the common electrode is, and the conductive light-blocking portion at least partly constitutes a plurality of position detection wires connected to the plurality of respective position detection electrodes.

13. The display device according to claim 12, comprising
an image wire disposed on the array substrate and being more remote from the counter substrate than the conductive light-blocking portion is, the image wire overlapping the conductive light-blocking portion with at least the inter-electrode insulating film interposed between the image wire and the conductive light-blocking portion, the image wire being connected to the plurality of pixel electrodes,
wherein the conductive light-blocking portion partly overlaps the plurality of position detection electrodes, but does not overlap the partitioning opening, and the conductive light-blocking portion partly constitutes a dummy wire connected to an overlapping position detection electrode included in the plurality of position detection electrodes.
